(19) United States
(12) Patent Application Publication
(10) Pub. No.: US 2007/0034326 A1
(43) Pub. Date: Feb. 15, 2007

(54) Method for producing flexible laminate

(76) Inventors: Takashi Kikuchi, Shiga (JP); Hiroyuki Tsuji, Shiga (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/579,942

(22) PCT Filed: Dec. 20, 2004
(86) PCT No.: PCT/JP04/19493

§ 371 Date: May 22, 2006

(30) Foreign Application Priority Data
Dec. 26, 2003 (JP) 2003-434027

(51) Int. Cl. B32B 37/00

(52) U.S. Cl. 156/247

(57) ABSTRACT

It is an object of the present invention to provide a method for producing a flexible laminate in which the appearance and dimensional stability after removal of metal foils are improved. The present invention provides a method for producing a flexible laminate 5 including a heat-resistant adhesive film 3 and a metal foil 2 bonded to at least one surface of the heat-resistant adhesive film 3. The method includes a step of performing thermal lamination by passing the heat-resistant adhesive film 3 and the metal foil 2 between a pair of metal rolls 4 through a protective film 1, and a step of separating the protective film 1. The molecular orientation ratio of the protective film 1 is in a range of 1.0 to 1.7.

### TECHNICAL FIELD

The present invention relates to a method for producing a flexible laminate including a thermal lamination step. More particularly, the invention relates to a method for producing a flexible laminate in which the appearance and dimensional stability after removal of metal foils are improved.

### BACKGROUND ART

Flexible laminates, which are produced by bonding metal foils, such as copper foils, onto at least one surface of heat-resistant films, such as polyimide films, have been commonly used as printed circuit boards for electrical devices, for example, cellular phones.

In the past, flexible laminates have been generally produced by bonding heat-resistant films and metal foils using adhesives, such as acrylic or epoxy adhesives. However, attention has recently been directed to flexible laminates produced by thermal lamination of heat-resistant adhesive films and metal foils without using thermosetting adhesives, such as acrylic or epoxy adhesives, in view of heat resistance and durability.

The flexible laminates produced by thermal lamination of heat-resistant adhesive films and metal foils have excellent heat resistance because of the presence of polyimide adhesive layers in the heat-resistant adhesive films. Furthermore, when flexible laminates are used in hinges of folding parts of foldable cellular phones, while flexible laminates using thermosetting adhesives withstand about 30,000 times of folding, flexible laminates using polyimide adhesive layers withstand about 100,000 times of folding. Thus, the flexible laminates using polyimide adhesive layers have excellent durability.

In the manufacturing process of electrical devices, flexible laminates are exposed to high temperatures during a solder reflow step, etc. Therefore, in order to improve thermal reliability of flexible laminates, heat-resistant adhesive films including polyimide thermally adhesive layers having a glass transition temperature (Tg) of 200° C. or more as adhesive layers are commonly used. Consequently, in order to thermally laminate the heat-resistant adhesive films with metal foils, thermal lamination must be performed at temperatures higher than the Tg of the thermally adhesive resin layers functioning as adhesive layers, for example, at 300° C. or more.

Generally, in a thermal laminator, in order to reduce nonuniformity in pressure during thermal lamination, at least one of the rolls used for thermal lamination is a rubber roll. However, it is extremely difficult to perform thermal lamination at high temperatures of 300° C. or more using rubber rolls. Therefore, thermal laminators equipped with a pair of metal rolls are used. However, when thermal lamination is performed using a pair of metal rolls, unlike the use of rubber rolls, it is difficult to maintain uniformity of pressure during thermal lamination.

Moreover, since the temperature rapidly changes during thermal lamination, wrinkles occur in the appearance of the resulting flexible laminate, thereby degrading the appearance of the flexible laminate. Consequently, a technique for improving the appearance defects has been proposed in which, when a heat-resistant adhesive film and metal foils are bonded to each other using a thermal laminator, a protective film is disposed between a pair of heating rolls (e.g., refer to Japanese Unexamined Patent Application Publication No. 2001-129918).

In this technique, since the protective film is disposed on the outer surface of the metal foil during thermal lamination of the metal foil and the heat-resistant adhesive film, the protective film reduces the concentration of heat and pressure in the metal foil and the heat-resistant adhesive film, and also suppresses expansion and shrinkage of the metal foil and the heat-resistant adhesive film, and thus appearance defects, such as wrinkles, are prevented.

However, Japanese Unexamined Patent Application Publication No. 2001-129918 does not take into consideration the molecular orientation and its deviation of the protective film, and does not describe dimensional changes of the resulting flexible laminate.

### DISCLOSURE OF INVENTION

In order to overcome the problems described above, it is an object of the present invention to provide a method for producing a flexible laminate in which the appearance and dimensional stability after removal of metal foils are improved.

The present invention relates to a method for producing a flexible laminate having a metal foil bonded to at least one surface of the heat-resistant adhesive film. The method includes a step of performing thermal lamination of the heat-resistant adhesive film and the metal foil by passing them with a protective film through between a pair of metal rolls, and a step of separating the protective films. The molecular orientation ratio (hereinafter referred to as “MOR”) of the protective film is specifically in a range of 1.0 to 1.7, and the deviation of the molecular orientation ratio in each of the machine direction and the transverse direction of the protective film is 0.1 or less.

In the method for producing the flexible laminate according to the present invention, preferably, the linear expansion coefficient a of the protective film at 200° C. to 300° C. is in a range of (α₀−10) ppm/° C. to (α₀+10) ppm/° C., wherein α₀ is the linear expansion coefficient of the metal foil at 200° C. to 300° C. Preferably, the tensile elastic modulus of the protective film at 25° C. is in a range of 2 GPa to 10 GPa. Preferably, the thickness of the protective film is 75 μm or more. Furthermore, the protective film is preferably a non-thermoplastic polyimide film.

As described above, in accordance with the present invention, it is possible to provide a method for producing a flexible laminate in which the appearance and dimensional stability after removal of the metal foil are improved.

### BRIEF DESCRIPTION OF THE DRAWINGS

FIG. 1 is a schematic diagram showing a preferred example of a thermal laminator used in the present invention.

FIG. 2 is a schematic, enlarged cross-sectional view of a laminate used in the present invention.

FIG. 3 is a schematic, enlarged cross-sectional view of a flexible laminate produced in accordance with the present invention.

In the drawings, reference numeral 1 represents a protective film, 2 represents a metal foil, 3 represents a heat-resistant adhesive film, 4 represents a metal roll, 5 represents a flexible laminate, 6 represents a separating roll, and 7 represents a laminate.

### BEST MODE FOR CARRYING OUT THE INVENTION

Embodiments of the present invention will be described below. In the drawings of the present application, the same reference numeral represents the same or corresponding element.

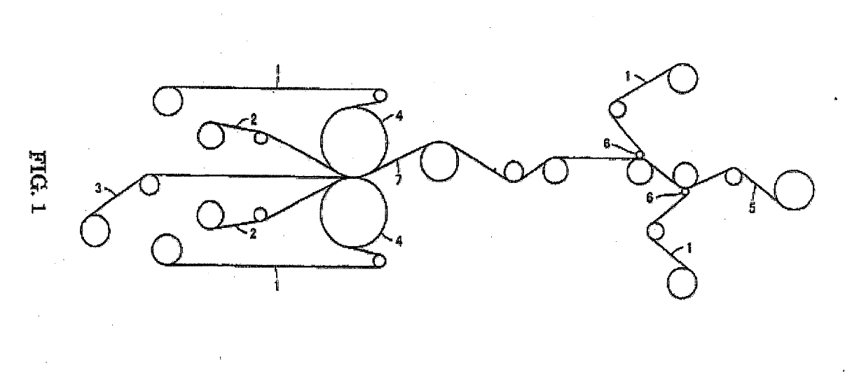

FIG. 1 is a schematic diagram showing a preferred example of a thermal laminator used in the present invention. The thermal laminator includes a pair of metal rolls 4 for thermally laminating metal foils 2 and a heat-resistant adhesive film 3 through protective films 1, and separating rolls 6 for separating the protective films 1.

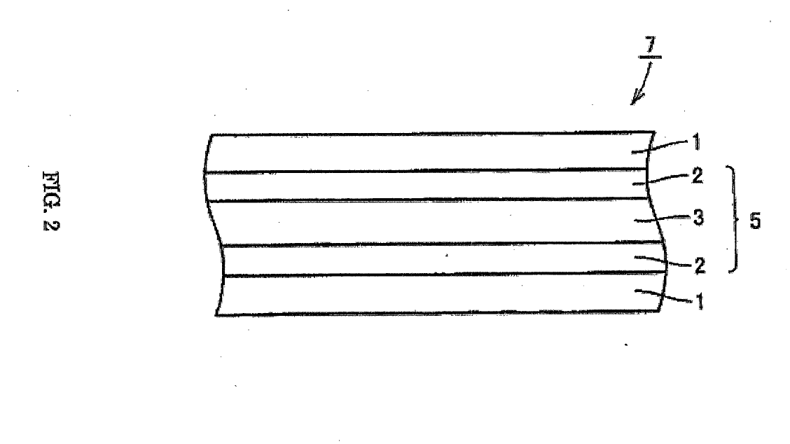

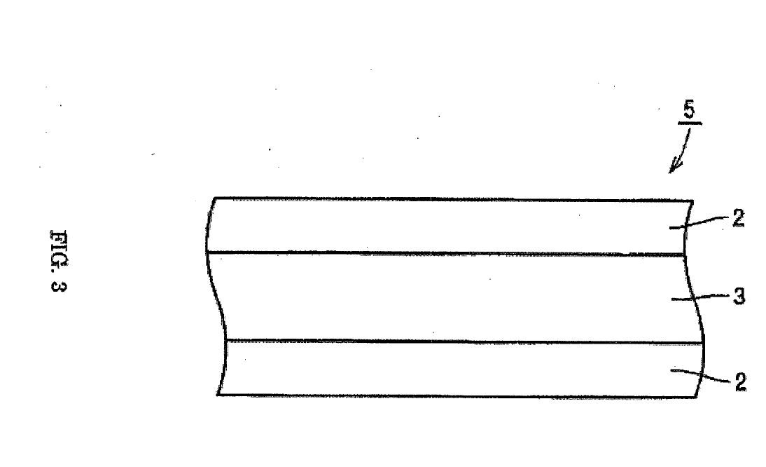

In one method for producing a flexible laminate according to the present invention, referring to FIG. 1, in the laminator, the heat-resistant adhesive film 3 and the metal foils 2 are thermally laminated between a pair of metal rolls 4 through the protective film 1. After the thermal lamination, a laminate 7 shown in the enlarged cross-sectional view of FIG. 2 is produced, the laminate 7 including a flexible laminate 5 comprising the heat-resistant adhesive film 3 and the metal foils 2, and the protective films 1 laminated to the flexible laminate 5. The laminate 7 is transferred by a plurality of rolls while being cooled. Furthermore, the protective films 1 are separated from the laminate 7 by the separating rolls 6, and thereby the flexible laminate 5 shown in the enlarged cross-sectional view of FIG. 3 is produced.

In the present invention, as the protective film 1, a film with a MOR of 1.0 to 1.7 is used. The present inventors have found that a polyimide film used as the protective film is generally anisotropic with respect to molecular orientation, and because of the anisotropy, there are differences in restraint against expansion and shrinkage of the metal foil and the heat-resistant adhesive film, which may result in appearance defects, such as wrinkles. Furthermore, the present inventors have found that when wirings and/or circuits are formed by at least partially etching the metal foil in the flexible laminate, because of the residual stress after the thermal lamination of the flexible laminate, in some cases, the ratio of dimensional change after removal of the metal foils is increased.

In the present invention, by using a protective film having low anisotropy with respect to molecular orientation, the expansion and the shrinkage of the heat-resistant adhesive film and the metal foil are uniformly restrained in all directions, and thereby, the appearance and dimensional stability after removal of the metal foils of the flexible laminate can be improved. From such a standpoint, the MOR of the protective film is preferably 1.0 to 1.5, and more preferably 1.0 to 1.3.

In the present invention, the MOR of a protective film is determined as follows. The protective film is introduced into a microwave waveguide resonator so that the film plane is perpendicular to the traveling direction of microwaves, microwaves are transmitted through the protective film while the protective film is being rotated, and the intensity of the electric field of the transmitted microwave (hereinafter referred to as the intensity of transmitted microwave) is measured. The ratio of the maximum to the minimum of the intensity of transmitted microwave is defined as the MOR. Since the MOR thus obtained is proportional to the thickness of the film, in the present invention, the MOR of the protective film is converted into a value at a thickness of 75 μm.

The MOR of the protective film can be appropriately adjusted depending on the production conditions of the protective film. It is not possible to clearly mention the production conditions because changes in the individual steps affect the subsequent steps. For example, when the protective film is a polyimide film, the MOR value of the polyimide film can be brought close to 1.0 by the following methods:
1) To control the amount of the remaining solvent for a polyamic acid film, which is a precursor, and
2) After the formation of the film, to control the expansion and shrinkage of the film in a tenter oven or to control the temperature distribution in the tenter oven.

Furthermore, the MOR value can be increased, for example, by uniaxial stretching during the formation of the film.

In this embodiment, it is also important that the deviation of the molecular orientation ratio in each of the machine direction (hereinafter referred to as MD) and the transverse direction (hereinafter referred to as TD) of the protective film 1 be 0.1 or less. By decreasing the deviation of the molecular orientation ratio, the expansion and shrinkage of the heat-resistant adhesive film and the metal foil can be suppressed more uniformly in all directions during the thermal lamination, and thereby the appearance of the flexible laminate and dimensional stability after removal of the metal foils can be further improved. From such a standpoint, in each of the MD and the TD, the deviation of the molecular orientation ratio is preferably 0.08 or less, and more preferably 0.05 or less. In the present invention, in order to determine the deviation of the molecular orientation ratio, with respect to the entire surface of a protective film to be used, the molecular orientation is measured every 0.3 m in the MD and every 0.3 m in the TD, and it is checked if the deviation of the molecular orientation is 0.1 or less. In order to confirm the deviation of the molecular orientation ratio in the protective film, measurement of every 0.3 m is sufficient. Additionally, when a long film is used, in order to confirm the deviation of the molecular orientation ratio, the MOR is measured with respect to 2 m taken from each 100 m in length, and it is sufficiently checked if the deviation is 0.1 or less.

An example of the method for producing a protective film in which the deviation of the molecular orientation ratio is 0.1 or less is a method of precisely controlling the temperature range in a tenter oven.

Furthermore, the linear expansion coefficient α of the protective film 1 at 200° C. to 300° C. is preferably in a range of (α₀−0) ppm/° C. to (α₀+10) ppm/° C., wherein α₀ is the linear expansion coefficient of the metal foil at 200° C. to 300° C. Since the protective film is subjected to thermal lamination in contact with the metal foil, if the difference between the linear expansion coefficient α₀ of the protective film and the linear expansion coefficient α₀ of the metal foil increases, the residual stress of the flexible laminate increases. From such a standpoint, the linear expansion coefficient of the protective film is more preferably in a range of (α₀−5) ppm/° C. to (α₀₊₅) ppm/° C.

Furthermore, the tensile elastic modulus of the protective film 1 at 25° C. is preferably in a range of 2 GPa to 10 GPa. If the tensile elastic modulus is less than 2 GPa, the protective film may be stretched due to the tension during thermal lamination. If the tensile elastic modulus exceeds 10 GPa, the protective film becomes rigid, and the effect of reducing the concentration of heat and pressure in the metal foil and the heat-resistant adhesive film during thermal lamination may be spoiled. From such a standpoint, the tensile elastic modulus of the protective film at 25° C. is more preferably in a range of 4 GPa to 6 GPa.

Furthermore, the thickness of the protective film 1 is preferably 75 μm or more. If the thickness of the protective film is less than 75 μm, the effect of reducing the concentration of heat and pressure in the metal foil and the heat-resistant adhesive film during thermal lamination is decreased. From such a standpoint, the thickness of the protective film is more preferably 125 μm or more. On the other hand, the thickness of the protective film is preferably 225 μm or less. If the thickness of the protective film exceeds 225 μm, there is a possibility that troubles may occur; for example, heat is not easily conducted from the heating rolls during thermal lamination, and the protective film is not separated smoothly after thermal lamination.

Although not particularly limited, the protective film 1 is preferably a resin film in which isotropic molecular orientation can be obtained, i.e., the MOR can be brought close to 1.0. In view of excellent balance between heat resistance, durability, etc., the protective film 1 is more preferably a non-thermoplastic polyimide film. In the present invention, the non-thermoplastic polyimide film means a polyimide film which is not thermosetting and which does not exhibit plasticity at the lamination temperature. Examples of the non-thermoplastic polyimide film include a polyimide film in which the glass transition temperature is higher than the decomposition temperature, and a polyimide film in which the glass transition temperature is lower than the decomposition temperature but higher than the lamination temperature.

As the metal foil 2, for example, a copper foil, a nickel foil, an aluminum foil, or a stainless steel foil is used. The metal foil 2 may have a single-layer structure or a multi-layer structure including a rust preventive layer or a heat-resistant layer (e.g., a layer formed by plating chromium, zinc, nickel, or the like) provided on the surface of a metal foil. Above all, in view of conductivity and cost, a copper foil is preferably used as the metal foil 2. Examples of the type of copper foil include rolled copper foils and electrolytic copper foils. As the thickness of the metal foil 2 is decreased, the line width of the circuit patterns on the flexible laminate which is used as a printed circuit board can be decreased, and therefore, the thickness of the metal foil 2 is preferably 35 μm or less, and more preferably 18 μm or less.

As the heat-resistant adhesive film 3, a single-layer film composed of a thermally adhesive resin, a multi-layer film including a core layer which does not have a thermally ahhesive property and a thermally adhesive resin layer provided on one surface or both surfaces of the core layer, and the like may be used. As the thermally adhesive resin, a resin containing a thermoplastic polyimide component is preferably used. Examples of such a resin include thermoplastic polyimides, thermoplastic polyamide-imides, thermoplastic polyetherimides, and thermoplastic polyesterimides.

Among these, thermoplastic polyimides and thermoplastic polyesterimides are particularly preferably used. These thermally adhesive resins may be incorporated with a thermosetting component, such as an epoxy resin. Furthermore, as the core layer which does not have a thermally adhesive property, any film may be used as long as it reinforces the strength of the thermally adhesive layer composed of a thermally adhesive resin and retains heat resistance. For example, a non-thermoplastic polyimide film, an aramid film, a polyetheretherketone film, a polyethersulfone film, a polyarylate film, or a polyethylene naphthalate film may be used. In view of electrical characteristics (insulating property), use of a non-thermoplastic polyimide film is particularly preferable.

Furthermore, the linear expansion coefficient of the heat-resistant adhesive film 3 at 200° C. to 300° C. is in a range of (α₀−0) ppm/° C. to (α+10) ppm/° C., wherein α₀ is the linear expansion coefficient of the metal foil at 200° C. to 300° C. Since the heat-resistant adhesive film is bonded by adhesiveness to the metal foil, if the difference between the linear expansion coefficient of the heat-resistant adhesive film and the linear expansion coefficient α of the metal foil is increased, the residual stress of the flexible laminate increases. From such a standpoint, the linear expansion coefficient of the heat-resistant adhesive film is more preferably in a range of (α₀−5) ppm/° C. to (α₀+5) ppm/° C.

The temperature of thermal lamination by the metal rolls 4 is preferably higher than the glass transition temperature of the thermally adhesive resin in the heat-resistant adhesive film 3 by more than 50° C. In order to increase the thermal lamination rate, the thermal lamination temperature is more preferably higher than the glass transition temperature of the thermally adhesive resin in the heat-resistant adhesive film 3 by more than 100° C. Examples of the heating method for the metal rolls 4 include a heat medium circulating method, a hot-air heating method, and a dielectric heating method.

The pressure (line pressure) of the metal rolls 4 during the thermal lamination is preferably 49 N/cm to 490 N/cm. When the line pressure during the thermal lamination is less than 49 N/cm, the line pressure is excessively small, and adhesion between the metal foil 2 and the heat-resistant adhesive film 3 tends to be decreased. When the line pressure is greater than 490 N/cm, the line pressure is excessively large, and strains are generated in the flexible laminate 5. As a result, the dimensional change of the flexible laminate 5 after the removal of the metal foils 2 may be increased. From such a standpoint, the line pressure during the thermal lamination is more preferably 98 N/cm to 294 N/cm. Examples of the method for pressurizing using the metal rolls 4 include a hydraulic method, a pneumatic method, and a gap pressure method.

Although not particularly limited, in view of improvement in productivity, the thermal lamination rate is preferably 0.5 m/min or more, and more preferably 1 m/min or more.

Prior to the thermal lamination, from the standpoint of avoiding a rapid increase in temperature, the protective films 1, the metal foils 2, and the heat-resistant adhesive film 3 are preferably subjected to preheating. The preheating step can be carried out, for example, by bringing the protective films 1, the metal foils 2, and the heat-resistant adhesive film 3 into contact with heating rolls 4.

Furthermore, prior to the thermal lamination, preferably, a step of removing foreign matter from the protective films 1, the metal foils 2, and the heat-resistant adhesive film 3 is provided. In particular, in order to use the protective film 1 repeatedly, it is important to remove foreign matter attached to the protective film 1. In the foreign matter removal step, for example, foreign matter is removed by a cleaning treatment using water, a solvent, or the like, or using a sticky rubber roll. Above all, the method using the sticky rubber roll is preferable because of simplicity in equipment.

Furthermore, prior to the thermal lamination, a step of removing static electricity from the protective film 1 and the heat-resistant adhesive film 3 is preferably provided. In the step of removing static electricity, for example, static electricity are removed using air ionizer.

### EXAMPLES

The present invention will be described more specifically based on Examples and Comparative Example. In Examples and Comparative Examples, the MOR, the linear expansion coefficient, the appearance, and the ratio of dimensional change were measured or evaluated as follows.

[MOR]

The MOR of the protective film was measured using a microwave molecular orientation analyzer Model MOA2012A manufactured by KS Systems Co., Ltd. First, 4 cm×4 cm samples were taken from a protective film every 0.3 m in the MD and every 0.3 m in the TD.

The protective film, i.e., the sample, was introduced into a microwave waveguide resonator so that the film plane was perpendicular to the traveling direction of microwaves, microwaves were transmitted through the protective film while the protective film was being rotated, and the intensity of the electric field of the transmitted microwave (hereinafter referred to as the intensity of transmitted microwave) was measured. The MOR is a ratio of the maximum to the minimum of the intensity of transmitted microwave and is calculated according to the expression (1) below. That is, MOR values closer to 1 indicate more isotropic molecular orientation, and larger MOR values indicate more anisotropic molecular orientation. Additionally, the direction at which the intensity of transmitted microwave is minimum corresponds to the main axis of the molecular orientation.
MORₜ=(Maximum of intensity of transmitted microwave)/(Minimum of intensity of transmitted microwave) (1)

However, since the MOR thus obtained is proportional to the thickness of the film, as the MOR in the present invention, a converted value, MOR₇₅, corresponding to a film with a thickness of 75 μm is used. The MOR₇₅ is calculated according to the expression (2) below, wherein MORₜ is a measured MOR value of a protective film with a thickness t μm. The MOR₇₅ was measured at three or more points at intervals of 0.3 m in each of the MD and the TD.
MOR₇₅=1+(MORₜ−1)×75/t (2)
[Linear Expansion Coefficient]

The linear expansion coefficient corresponds to a ratio of relative change in length to change in temperature when an object thermally expands under a constant pressure. In the present invention, ppm/° C. is used as a unit. The linear expansion coefficients of the protective film, the heat-resistant adhesive film, and the metal foil were measured using a thermal mechanical analysis apparatus manufactured by Seiko Instruments Inc. (trade name: TMA (Thermomechanical Analyzer) 120C), in which, under nitrogen stream, after the temperature was increased from 20° C. to 400° C. at a rate of 10° C./min, the average values in a range of 200° C. to 300° C. measured in the temperature range of 20° C. to 400° C. increased at a rate of 10° C./min were obtained.

[Appearance]

The appearance of the flexible laminate was visually evaluated. In particular, by counting the number of wrinkles generated per square meter in the flexible laminate, the evaluation was conducted according to the following criteria:
excellent: No wrinkles
good: One or less wrinkles per square meter
poor: Two or more wrinkles per square meter
   [Ratio of Dimensional Change]

The ratio of dimensional change before and after removal of the metal foils was measured and calculated as described below according to JIS C6481. That is, a 200 mm×200 mm square sample was cut out from each flexible laminate, and a hole with a diameter of 1 mm was formed in each of the four corners of a 150 mm×150 mm square in the sample. Two sides of each of the 200 mm×200 mm square sample and the 150 mm×150 mm square were directed in the MD and the other two sides were directed in the TD. These two squares were arranged so as to have a common center. The sample was left to stand in a chamber with constant temperature and humidity at 20° C. and 60% RH for 12 hours to condition humidity, and then the respective distances among the four holes were measured. Subsequently, the metal foils were removed from the flexible laminate by etching, and the sample was left to stand in a thermostatic chamber at 20° C. and 60% RH for 24 hours. The respective distances among the four holes were measured in the same manner as that before the etching. The ratio of change in dimensions was calculated according to the expression (3) below, wherein D1 is an observed distance among the holes before removal of the metal foils, and D2 is an observed distance among the holes after removal of the metal foils. A smaller absolute value of the ratio of change in dimensions indicates higher dimensional stability.
Ratio of change in dimensions (%)={(D2−D1)/D1}×100 (3)

### Example 1

A flexible laminate was produced using a thermal laminator shown in FIG. 1. Rolls of a non-thermoplastic polyimide film as a protective film 1, the non-thermoplastic polyimide film having a MOR₇₅ of 1.07 to 1.10, a variation of MOR₇₅ per 0.3 m of 0.03 in each of the MD and the TD, a linear expansion coefficient of 12 ppm/° C., a tensile elastic modulus of 6 GPa, a thickness of 75 μm, and a width of 0.9 m; rolls of a copper foil as a metal foil 2, the copper foil having a linear expansion coefficient of 19 ppm/° C. and a thickness of 18 μm; and a roll of an adhesive film as a heat-resistant adhesive film 3, the adhesive film having a thickness of 25 μm and a three-layered structure including a core layer composed of a non-thermoplastic polyimide film and thermoplastic polyimide resin layers (glass transition temperature: 240° C.) provided on both surfaces of the core layer were installed in the thermal laminator.

Subsequently, static electricity and foreign matter were removed and preheating was performed by means of rotating these rolls. The non-thermoplastic polyimide films, the copper foils, and the adhesive film were thermally laminated using a pair of metal rolls 4 under the thermal lamination conditions (i.e., temperature: 360° C., line pressure: 196 N/cm, and thermal lamination rate: 1.5 m/min) to produce a laminate 7 having a five-layered structure in which the copper foils and the non-thermoplastic polyimide films were bonded in that order to both surfaces of the adhesive films.

After the laminate 7 was slowly cooled by a plurality of rolls, the non-thermoplastic polyimide films were separated from the copper foils by separating rolls 6 to produce a flexible laminate 5. With respect to this flexible laminate, the appearance was evaluated and dimensions were measured.

Furthermore, the copper foils of the flexible laminate were removed by etching, and the dimensions after the removal of the copper foils were measured, and the ratios of change in dimensions (MD and TD) before and after removal of the metal foils (copper foils) were calculated. The results thereof are shown in Table 1. As shown in Table 1, in the flexible laminate of Example 1, no wrinkles were observed, and the ratio of change in dimensions before and after removal of the metal foils was −0.03% in the MD and +0.02% in the TD.

The MOR of the protective film used was measured with respect to a point 0.15 m from an edge in the width direction of the film, 3 points from this point in the TD at the intervals of 0.3 m, and 5 points in the MD at the intervals of 0.3 m, 15 points in total, and the range of the MOR₇₅ and the dispersion of the MOR₇₅ per 0.3 m were calculated.

### Example 2

A flexible laminate was produced as in Example 1 except that as a protective film 1, a non-thermoplastic polyimide film having a MOR₇₅ of 1.07 to 1.10, a deviation of MOR₇₅ per 0.3 m of 0.03 in each of the MD and the TD, a linear expansion coefficient of 16 ppm/° C., a tensile elastic modulus of 4 GPa, a thickness of 75 μm, and a width of 0.9 m was used. The appearance was evaluated, and the ratio of change in dimensions before and after removal of the metal foils (copper foils) was calculated. The results thereof are shown in Table 1. In the flexible laminate of Example 2, no wrinkles were observed, and the ratio of change in dimensions before and after removal of the metal foils was −0.03% in the MD and +0.03% in the TD.

### Example 3

A flexible laminate was produced as in Example 1 except that as a protective film 1, a non-thermoplastic polyimide film having a MOR₇₅ of 1.25 to 1.30, a dispersion of MOR₇₅ per 0.3 m of 0.05 or less in each of the MD and the TD, a linear expansion coefficient of 12 ppm/° C., a tensile elastic modulus of 6 GPa, a thickness of 125 μm, and a width of 0.9 m was used. The appearance was evaluated, and the ratio of change in dimensions before and after removal of the metal foils (copper foils) was calculated. The results thereof are shown in Table 1. In the flexible laminate of Example 3, no wrinkles were observed, and the ratio of change in dimensions before and after removal of the metal foils was −0.03% in the MD and +0.03% in the TD.

### Example 4

A flexible laminate was produced as in Example 1 except that as a protective film 1, a non-thermoplastic polyimide film having a MOR₇₅ of 1.25 to 1.30, a dispersion of MOR₇₅ per 0.3 m of 0.05 or less in each of the MD and the TD, a linear expansion coefficient of 16 ppm/° C., a tensile elastic modulus of 4 GPa, a thickness of 75 μm, and a width of 0.9 m was used. The appearance was evaluated, and the ratio of change in dimensions before and after removal of the metal foils (copper foils) was calculated. The results thereof are shown in Table 1. In the flexible laminate of Example 4, no wrinkles were observed, and the ratio of change in dimensions before and after removal of the metal foils was −0.03% in the MD and +0.02% in the TD.

### Example 5

A flexible laminate was produced as in Example 1 except that as a protective film 1, a non-thermoplastic polyimide film having a MOR₇₅ of 1.25 to 1.30, a dispersion of MOR₇₅ per 0.3 m of 0.05 or less in each of the MD and the TD, a linear expansion coefficient of 16 ppm/° C., a tensile elastic modulus of 4 GPa, a thickness of 125 μm, and a width of 0.9 m was used. The appearance was evaluated, and the ratio of change in dimensions before and after removal of the metal foils (copper foils) was calculated. The results thereof are shown in Table 1. In the flexible laminate of Example 5, no wrinkles were observed, and the ratio of change in dimensions before and after removal of the metal foils was −0.03% in the MD and +0.02% in the TD.

### Example 6

A flexible laminate was produced as in Example 1 except that as a protective film 1, a non-thermoplastic polyimide film having a MOR₇₅ of 1.42 to 1.50, a dispersion of MOR₇₅ per 0.3 m of 0.08 or less in each of the MD and the TD, a linear expansion coefficient of 16 ppm/° C., a tensile elastic modulus of 4 GPa, a thickness of 75 μm, and a width of 0.9 m was used. The appearance was evaluated, and the ratio of change in dimensions before and after removal of the metal foils (copper foils) was calculated. The results thereof are shown in Table 1. In the flexible laminate of Example 6, no wrinkles were observed, and the ratio of change in dimensions before and after removal of the metal foils was −0.03% in the MD and +0.02% in the TD.

### Example 7

A flexible laminate was produced as in Example 1 except that as a protective film 1, a non-thermoplastic polyimide film having a MOR₇₅ of 1.60 to 1.70, a dispersion of MOR₇₅ per 0.3 m of 0.10 or less in each of the MD and the TD, a linear expansion coefficient of 16 ppm/° C., a tensile elastic modulus of 4 GPa, a thickness of 75 μm, and a width of 0.9 m was used. The appearance was evaluated, and the ratio of change in dimensions before and after removal of the metal foils (copper foils) was calculated. The results thereof are shown in Table 1. In the flexible laminate of Example 7, one or less wrinkles were generated per square meter, and the ratio of change in dimensions before and after removal of the metal foils was −0.04% in the MD and +0.03% in the TD.

### Comparative Example 1

A flexible laminate was produced as in Example 1 except that as a protective film 1, a non-thermoplastic polyimide film having a MOR₇₅ of 2.15 to 2.30, a dispersion of MOR₇₅ per 0.3 m of 0.15 or less in each of the MD and the TD, a linear expansion coefficient of 16 ppm/° C., a tensile elastic modulus of 4 GPa, a thickness of 125 μm, and a width of 0.9 m was used. The appearance was evaluated, and the ratio of change in dimensions before and after removal of the metal foils (copper foils) was calculated. The results thereof are shown in Table 1. In the flexible laminate of Comparative Example 1, two or more wrinkles were generated per square meter, and the ratio of change in dimensions before and after removal of the metal foils was −0.09% in the MD and +0.07% in the TD.

TABLE 1

| | | | | | | | | | Comparative |
|---|---|---|---|---|---|---|---|---|---|
| | | Example 1 | Example 2 | Example 3 | Example 4 | Example 5 | Example 6 | Example 7 | Example 1 |
| Protect film | MOR₇₅ | 1.07 to | 1.07 to | 1.25 to | 1.25 to | 1.25 to | 1.42 to | 1.60 to | 2.15 to |
| (Non- | | 1.10 | 1.10 | 1.30 | 1.30 | 1.30 | 1.50 | 1.70 | 2.30 |
| thermoplastic | Deviation of | 0.03 | 0.03 | 0.05 | 0.05 | 0.05 | 0.08 | 0.10 | 0.15 |
| polyimide | MOR₇₅ per 0.3 m | or less | or less | or less | or less | or less | or less | or less | or less |
| film) | Linear expansion | 12 | 16 | 12 | 16 | 16 | 16 | 16 | 16 |
| | coefficient | | | | | | | | |
| | (ppm/° C.) | | | | | | | | |
| | Tensile elastic | 6 | 4 | 6 | 4 | 4 | 4 | 4 | 4 |
| | modulus (GPa) | | | | | | | | |
| | Thickness (μm) | 75 | 75 | 125 | 75 | 125 | 75 | 125 | 125 |
| Metal foil | Linear expansion | 19 | 19 | 19 | 19 | 19 | 19 | 19 | 19 |
| (Copper | coefficient | | | | | | | | |
| foil) | (ppm/° C.) | | | | | | | | |
| Flexible | Appearance | excellent | excellent | excellent | excellent | excellent | excellent | good | poor |
| laminate | Ratio of change | MD: −0.03 | MD: −0.03 | MD: −0.03 | MD: −0.03 | MD: −0.03 | MD: −0.03 | MD: −0.04 | MD: −0.09 |
| | in dimensions | TD: +0.02 | TD: +0.03 | TD: +0.03 | TD: +0.02 | TD: +0.02 | TD: +0.02 | TD: +0.03 | TD: +0.07 |
| | before and | | | | | | | | |
| | after removal of | | | | | | | | |
| | metal foils (%) | | | | | | | | |

As is evident from Table 1, with respect to the flexible laminate produced using the protective film having a MOR₇₅ of 1.0 to 2.0, the number of wrinkles generated per square meter is one or less, and thus excellent appearance is shown. Furthermore, the ratio of change in dimensions is within a range of −0.05% to +0.05% in each of the MD and the TD, and thus extremely high dimensional stability is shown. If the ratio of change in dimensions before and after. removal of the copper foils is in the range of −0.05% to +0.05%, even when fine wirings are formed in the flexible laminate, dimensional accuracy is ensured. Furthermore, with respect to the flexible laminate produced using the protective film having a MOR₇₅ of 1.0 to 1.5, no wrinkles are observed and the appearance is further improved.

The above-disclosed embodiments and examples are provided for the illustrative purpose only and do not limit the present invention. The present invention shall only be limited to the range defined in the following claims and includes any equivalent of the claims and modifications without departing from the spirit of the present invention.

### INDUSTRIAL APPLICABILITY

As described above, the present invention can be widely applied to methods for producing flexible laminates in order to improve the appearance and dimensional stability after removal of metal foils.

1. A method for producing a flexible laminate comprising a heat-resistant adhesive film having a metal foil bonded to at least one side thereof, the method comprising:
a step of performing thermal lamination of the heat-resistant adhesive film and the metal foil by passing them with protective films through between a pair of metal rolls; and
a step of separating the protective films, and
wherein the molecular orientation ratio of the protective film is in a range of 1.0 to 1.7, and the deviation of the molecular orientation ratio in each of the machine direction and the transverse direction of the protective film is 0.1 or less.

2. The method for producing the flexible laminate according to claim 1, wherein the linear expansion coefficient α of the protective film at 200° C. to 300° C. is in a range of (α₀−10) ppm/° C. to (α₀+10) ppm/° C., wherein α₀ is the linear expansion coefficient of the metal foil at 200° C. to 300° C.

3. The method for producing the flexible laminate according to claim 1 or claim 2, wherein the tensile elastic modulus of the protective film at 25° C. is in a range of 2 GPa to 10 GPa.

4. The method for producing the flexible laminate according to claim 1 or claim 2, wherein the thickness of the protective film is 75 μm or more.

5. The method for producing the flexible laminate according to claim 1 or claim 2, wherein the protective film is a non-thermoplastic polyimide film.

6. The method for producing the flexible laminate according to claim 3, wherein the thickness of the protective film is 75 μm or more.

7. The method for producing the flexible laminate according to claim 3, wherein the protective film is a non-thermoplastic polyimide film.

8. The method for producing the flexible laminate according to claim 4, wherein the protective film is a non-thermoplastic polyimide film.
